(19) United States
(12) Patent Application Publication
(10) Pub. No.: US 2025/0318567 A1
(43) Pub. Date: Oct. 16, 2025

(54) Apparatus and Method of Manufacturing a Meat Jerky Straw

(71) Applicant: Sammark Holdings, LLC, Glendale, WI (US)

(72) Inventor: Sam J. Maglio, JR., Mequon, WI (US)

(21) Appl. No.: 19/250,506

(22) Filed: Jun. 26, 2025

Related U.S. Application Data
(63) Continuation-in-part of application No. 17/351,496, filed on Jun. 18, 2021.
(60) Provisional application No. 63/040,744, filed on Jun. 18, 2020.

(51) Int. Cl. A23P 30/25; A23B 4/03; A23B 4/10

(52) U.S. Cl. CPC A23P 30/25; A23B 4/03; A23B 4/10

(57) ABSTRACT

An apparatus and method for making meat jerky in the form of a thin-walled and narrow tubes uses a food extruder extruding a meat mixture through a tubular opening die and coating the meat mixture with a solution of calcium chloride to firm the meat mixture in the tubular form without collapsing. The present invention provides a reproducible process for creating meat jerky tubes with consistent length, width, and size portion.

### CROSS REFERENCE TO RELATED APPLICATION

This application is a continuation-in-part (CIP) application of U.S. application Ser. No. 17/351,496, filed Jun. 18, 2021, which claims the benefit of U.S. Provisional Application No. 63/040,744, filed Jun. 18, 2020, both of which are hereby incorporated by reference.

### BACKGROUND OF THE INVENTION

The present invention relates generally to an apparatus and method of making a tube of dried meat and, in particular, to a method of making meat or beef jerky in the form of a thin-walled tube with a small diameter permitting the meat or beef jerky to be used inside a beverage as a drinking straw and edible food item flavoring the beverage.

Jerky products are lean trimmed meats that are typically cut into strips and dehydrated for consumption. Jerky is commonly made from meat of domesticated animals such as beef, pork, goat and mutton or lamb and game animals such as deer, kudu, springbok, kangaroo, and bison.

The process of making jerky typically requires fat to be removed since fat does not dry and increases the risk of spoilage. Before the meats are dehydrated using a low temperature drying method there is the addition of salt to prevent bacteria growth. Chemical preservatives such as sodium nitrite may be used with the salting process to help prevent bacterial growth in the meat. Then the meat must be dried quickly (the “critical period”) under low temperatures so that the meat does not cook and to limit the bacterial growth. Large low temperature drying ovens or dehydrators with multiple heaters and fans are used to heat the meat placed on screens while removing the humidity in the air. Typically, to assist quick drying, the meat is sliced or pressed thin to increase the surface area of meat exposed to the air.

The preparation and dehydration process used to make jerky normally requires the removal of fat, the addition of salt and chemical preservatives, and quick drying under low temperatures. The process depends on the preparation of the meat to prevent bacterial growth and thin, flat slices to facilitate drying during the “critical period”.

### SUMMARY OF THE INVENTION

The present invention provides a meat jerky making system which produces the meat jerky in thin-walled narrow tubes that may be used as drinking straws to flavor the beverage but may be further consumed after use. The process is more difficult than producing thin, flat slices of jerky since the meat must be extruded into a tube form with low fat content, making it more difficult to keep the meat mixture together and maintained in the long tube form without collapsing. Then, the narrow tube must be dried quickly (to limit bacterial growth) despite its high length-to-diameter (L/D) ratio which is prone to deformation/buckling and collapse.

The present invention provides a method of making a tube of dried meat including forming a meat composition comprising ground meat and sodium alginate; passing the meat composition along an axis through a die having a ring-shaped opening with an outer diameter concentric about the axis and an inner diameter concentric about the axis and the meat composition forced out between the inner and outer diameter to form a tube of extruded meat; coating at least one of an inner and outer surface of the tube of extruded meat with a solution of calcium chloride; and drying the extruded tube of meat to remove moisture from the extruded tube.

It is thus a feature of at least one embodiment of the present invention to provide a thin-walled meat extrusion process for producing meat jerky tubes to be used as drinking straws without collapsing of the tubes prior to the drying or dehydration process.

The solution of calcium chloride may be 0.5 to 1.5 wt % calcium chloride. The meat composition may be 0.5 to 1.5 wt % sodium alginate. In alternative embodiments, the solution of calcium chloride may be 5 to 15 wt % calcium chloride. The meat composition may be less than 1 wt % sodium alginate.

It is thus a feature of at least one embodiment of the present invention to provide firming of the extruded meat tube prior to slicing and drying or dehydration to form a firm tube that has structural integrity.

The meat composition may be 85 to 95 wt % ground meat. The meat composition may further include an additive comprising at least one of seasoning mixture, sodium nitrite and curing salt.

It is thus a feature of at least one embodiment of the present invention to provide meat mixtures that allow for the production of meat or beef jerky with the expected jerky appearance and flavor.

The method may further include the step of spraying the inner and outer surfaces of the extruded tube of meat with the solution of calcium chloride.

It is thus a feature of at least one embodiment of the present invention to coat both walls of the extruded tube of meat to firm the structure of the tube and prevent collapsing of the tube when slicing into smaller tube lengths.

The method may further include the step of dripping the solution of calcium chloride onto the extruded tube of meat.

It is thus a feature of at least one embodiment of the present invention to coat the meat mixture with the firming solution without placing high sprayer forces onto the soft meat mixture.

The extruded tube of meat may be further cut into predetermined tube segment lengths.

It is thus a feature of at least one embodiment of the present invention to provide an easy to package and consumable food product.

The extruded tube of meat may be coated with calcium chloride for at least 10 seconds prior to being cut into predetermined tube segment lengths.

It is thus a feature of at least one embodiment of the present invention to allow time for the calcium chloride solution to react with the meat mixture in order for the meat mixture to firm prior to slicing.

The predetermined tube segments may be between 6 and 10 inches in length.

It is thus a feature of at least one embodiment of the present invention to provide a standard length commensurate with a drinking straw.

The predetermined tube lengths may include approximately 1 to 2 oz. of extruded meat mixture.

It is thus a feature of at least one embodiment of the present invention to provide a consumable food product that may be consumed following use as a drinking straw.

The extruded tube of meat may be dried for 2 to 8 hours at a temperature of at least 150 degrees Fahrenheit. The extruded tube may have a moisture to protein ratio of 0.75:1 or lower.

It is thus a feature of at least one embodiment of the present invention to provide dried meat that may be firm and dried enough to withstand liquid contact such as would be encountered when immersed within a drink during drinking straw use. It is also a feature of at least one embodiment of the present invention to provide a drinking straw that can withstand at least 8 hours of liquid immersion without collapsing.

The present invention also provides a method of making a tube of dried meat including providing an assembly for making a tube of dried meat having a hopper receiving a meat mixture comprising ground meat and sodium alginate; an extruder passing the meat mixture from the hopper through a barrel translating the meat mixture along the barrel; a die having a ring shaped opening and permitting the meat mixture to be fed through the die to produce a tube of extruded meat having an inner surface and an outer surface; and a blade slicing the tube of extruded meat into predetermined tube lengths. The method further includes loading the meat mixture into the hopper; extruding the meat mixture through the die; coating the inner surface and outer surface of the tube of extruded meat with a solution of calcium chloride; slicing the tube of extruded meat into predetermined tube lengths; and drying the predetermined tube lengths to a moisture to protein ratio of 0.75:1 or lower.

It is thus a feature of at least one embodiment of the present invention to provide an apparatus for producing extruded meat tubes that allow for rapid firming of the extruded meat tubes.

The assembly may further comprise a conveyor belt receiving the tube of extruded meat from the die.

It is thus a feature of at least one embodiment of the present invention to allow additional time for the meat tubes to firm during the automated assembly process of extrusion and portioning/cutting.

The assembly further comprises a trough holding the solution of calcium chloride and dripping the solution of calcium chloride onto the tube of extruded meat from the die. The trough may be held above the conveyor belt to drip the solution of calcium chloride onto the conveyor belt.

It is thus a feature of at least one embodiment of the present invention to gently coat the meat mixture with a firming solution without damaging the structure of the meat tube.

The assembly may further comprise an inner spray tube and outer spray tube coating the inner surface and the outer surface, respectively, of the tube of extruded meat.

It is thus a feature of at least one embodiment of the present invention to coat the inside and outside of the meat tube for firming both surfaces of the tube structure.

The present invention further provides a method of making a drinking straw of dried meat comprising forming a meat composition comprising ground meat and sodium alginate; passing the meat composition along an axis through a die having a ring-shaped opening with an outer diameter and inner diameter concentric about the axis with the meat composition extruded between the inner diameter and outer diameter of the ring-shaped opening to form a narrow tube of extruded meat; spraying an inner surface of the tube of extruded meat with a solution of calcium chloride; cutting the tube of extruded meat into predetermined length tubes; submerging the smaller length tubes within a bath of the solution of calcium chloride; and drying the predetermined length tubes to remove moisture from the extruded meat. The predetermined length tubes may have a length-to diameter ratio of at least 10:1.

It is thus a feature of at least one embodiment of the present invention to provide a method of manufacture of dried meat in a tube form that does not collapse during the firming process and drying process despite the high length-to-diameter ratio.

The method may further comprise rinsing the smaller length tubes within a bath of water before drying the predetermined length tubes.

It is thus a feature of at least one embodiment of the present invention to remove the saltiness of the higher concentration calcium chloride solution which is used to firm the meat mixture.

The method may further comprise extending a spray tubing through a center of the die; and emitting the solution of calcium chloride through an open end of the spray tubing. The solution of calcium chloride may be emitted at 20-40 psi. The solution of calcium chloride may be emitted at approximately 20 psi.

It is thus a feature of at least one embodiment of the present invention to penetrate the walls of the meat tubes with calcium chloride solution by coating all surfaces.

The submerging of the smaller length tubes within the bath of the solution of calcium chloride may be for at least one minute. The submerging of the smaller length tubes within the bath of the solution of calcium chloride may be for three to four minutes.

It is thus a feature of at least one embodiment of the present invention to counteract the pressure on the interior of the tubes by submerging in the solution to prevent holes.

The solution of calcium chloride may be at least 5 wt % calcium chloride. The solution of calcium chloride may be 5-15 wt % calcium chloride. The solution of calcium chloride may be approximately 10 wt % calcium chloride.

It is thus a feature of at least one embodiment of the present invention to provide rapid firming of the meat tube.

The predetermined length tubes may have a water activity of 0.71-0.79 after drying.

It is thus a feature of at least one embodiment of the present invention to preserve shelf life and prevent fast spoilage by reducing the availability of water and the ability of microorganisms to grow.

The present invention further provides an assembly for making a drinking straw of dried meat comprising a hopper receiving a meat mixture; an extruder passing the meat mixture from the hopper through a barrel translating the meat mixture along the barrel; a die having a ring shaped opening and permitting the meat mixture to be fed through the die to produce a tube of extruded meat having an inner lumen and an outer surface; a cutting instrument slicing the tube of extruded meat into predetermined tube lengths; a tube extending through the die configured to spray the inner lumen of the tube of extruded meat with a solution of calcium chloride; and a bath of the solution of calcium chloride to coat the outer surface of the tube of extruded meat with a solution of calcium chloride.

It is thus a feature of at least one embodiment of the present invention to provide a calcium chloride coating process which coats the inner lumen of the meat tubes with nozzle pressure and then submerges the tubes within calcium chloride solution to provide integration of the calcium chloride with sodium alginate in the meat.

The assembly may further comprise of a support rack having at least one valley extending along an axis wherein the cross section is taken perpendicular to the axis is U-shaped and receiving the tube of extruded meat along the axis within the at least one valley.

It is thus a feature of at least one embodiment of the present invention to allow the fluidity of the firming tubes to fall into the “mold” of the support rack providing straightness to the tubes.

The cutting instrument may be a blade configured to slide across the opening of the die. The cutting instrument may alternatively be a wire configured to slide across the opening of the die.

It is thus a feature of at least one embodiment of the present invention to provide a clean, even, smooth cut with the reduced surface area of the wire preventing meat from sticking to the wire.

The meat mixture may be 90 to 95 wt % ground beef and 0.5 to 1.5 wt % sodium alginate. The meat mixture may further comprise of spices and curing salt.

These particular objects and advantages may apply to only some embodiments falling within the claims and thus do not define the scope of the invention.

### BRIEF DESCRIPTION OF THE DRAWINGS

FIG. 1 is a perspective view of a meat tube manufacturing system with an exemplary vacuum filler machine of the present invention as used for the extrusion of a meat mixture into the form of thin-walled hollow tubes which are further fed to a portioning/cutting assembly;

FIG. 2 is an enlarged front planar view of the portioning/cutting assembly of FIG. 1 showing the die with tube opening surrounded by a spray tube apparatus for coating the extruded meat mixture tubes with calcium chloride solution on an inner surface and/or outer surface of the tubes;

FIG. 3 is a simplified side cross sectional view of the portioning/cutting assembly of FIG. 1 showing the meat path leading to the die and cutting instrument;

FIG. 4 is a flow chart showing the steps for the process of meat jerky making according to the present invention;

FIG. 5 is a simplified schematic top elevation view of an alternative embodiment of the present invention showing the vacuum filler machine being used to extrude meat mixture tubes onto a conveyor belt where it may harden before being further transported to a portioning/cutting assembly;

FIG. 6 is a simplified schematic side cross sectional view of the alternative embodiment of FIG. 5 showing a trough held above the conveyor belt for dripping calcium chloride solution onto the extruded meat mixture tubes while on the conveyor belt prior to portioning/cutting;

FIG. 7 is a simplified schematic top elevation view of an alternative embodiment of the present invention showing an immersion tank directly receiving the cut meat mixture tubes from the portioning/cutting assembly of FIGS. 2 and 3 and further showing a second tank for rinsing the meat mixture tubes before drying on a collection tray; and

FIG. 8 is a perspective view of a tube drying rack for drying the cut meat mixture tubes in straight lines.

### DETAILED DESCRIPTION OF THE PREFERRED EMBODIMENT

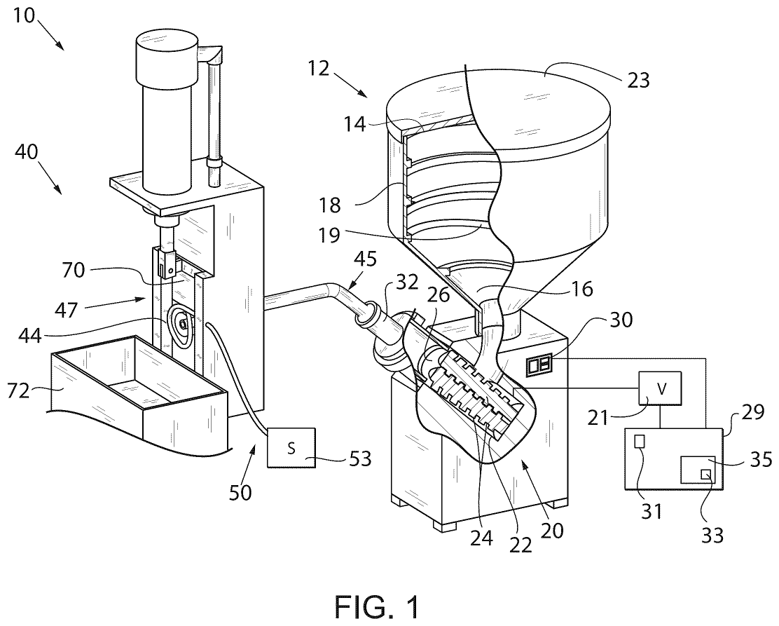

Referring to FIG. 1, a method of making meat jerky in accordance with the present invention may utilize a vacuum filler machine 10 used to dispense reproducible length, width, and size portions of soft mixtures such as soft meat mixtures.

A hopper 12 of the vacuum filler machine 10 may comprise a funnel 18 that is wide on a top end 14 and narrow on a bottom end 16 and which receives the meat mixture 28 poured through the open top end 14 and then compressed within the hopper 12 by a spiral feed screw 19 which rotates along an inner wall of the funnel 18 to feed the meat mixture 28 downwards toward the bottom end 16 of the funnel 18 to then further enter an extruder, for example, a single or twin-screw system 20 (a twin-screw system is shown in FIG. 1) positioned below the hopper 12 which, with the aid of a vacuum system 21, helps to move or “suck” the meat mixture 28 downwards to the twin-screw system 20. A scraper (not shown) which is swiped along the inner surface of the funnel 18 may be used to ensure that the meat mixture 28 is substantially emptied from the hopper 12 into the twin-screw system 20.

The spiral feed screw 19 and/or the twin-screw system 20 may turn off automatically if a cover 23 over the top end 14 of the hopper 12 is not closed thereover to prevent accidental injury which may be caused by accidentally contacting the spiral feed screw 19 and/or the twin-screw system 20 while in operation.

The twin-screw system 20 may include a cylindrical barrel 22 holding a pair of parallel threaded screws 24 that extend at an upward angle from a position below the hopper 12 to an outlet 26 of the cylindrical barrel 22. The threads of the threaded screws 24 may receive the meat mixture 28 from the hopper 12 and then convey the meat mixture 28 gently and evenly along the twin-screw system 20 in an upward direction to the outlet 26. Air may be withdrawn from the meat mixture 28 through the vacuum system 21 associated with the twin-screw system 20. It is understood that the twin-screw system 20 as shown may alternatively be a single screw system including a single threaded screw, as understood in the art, or other types of food extruders known in the art.

In order to control the consistent size portions of meat mixture 28 delivery, the twin-screw system 20 provides that the same volume of meat mixture 28 is dispensed with each rotation of the threaded screws 24. Therefore, the speed of the screws 24 may be adjusted to change the quantity of the product dispensed, for example, through a graphic display and user input interface 30. The user may be able to turn the vacuum filler machine 10 on and off, turn the vacuum system 21 on and off, control the vacuum system 21 to increase or decrease the vacuum, control the speed of rotation of the threaded screws 24, etc., all through the user input interface 30.

The vacuum system 21 and the twin-screw system 20 may be controlled by a controller 29 including a processor 31 executing a stored program 33 in computer memory 35 communicating with the graphic display and user input interface 30 to control the various components as described or may be implemented as discrete circuitry according to techniques well known in the art. For example, the controller 29 may control a motor of the twin-screw system 20 driving rotation of the threaded screws 24 of the twin-screw system 20 and may also control power to the vacuum system 21 to control a power level of the vacuum.

The meat mixture 28, which will be described in further detail below, may be continuously dispensed by the twin-screw system 20 or in individual portions with the number of screw rotations relating to a measure of the weight and/or volume of an individual portion. The twin-screw system 20 may be fed until the meat mixture 28 is fully dispensed from the threaded screws 24. It is understood that a single portion of meat mixture 28 from the twin-screw system 20 may be further portioned to provide multiple meat tubes by a portioning assembly 40 as further described below.

The vacuum filler machine 10 used in connection with the present invention may be, for example, the vacuum filler machine 10 commercially sold under the trade name “ROBOT500” manufactured by Vemag of Verden, Germany. Although the present invention is being described with respect to use of a vacuum filler machine 10 as manufactured by Vemag, other vacuum filler machines and food extruders may be used in connection with the present invention, for example, multi co-extruders manufactured by Rheon Automatic Machinery Co. of Japan and the like, and in a similar manner.

The vacuum filler machine 10 used in connection with the present invention may be as described in U.S. Pat. No. 6,132,302, filed Oct. 8, 1998, entitled “Device for filling casings as well as machine for filling sausage casings”; U.S. Pat. No. 8,757,865, filed Sep. 19, 2013, entitled “Foodstuff conveyor apparatus and method of conveying a foodstuff”; and U.S. Publication 2010/0199862, filed Dec. 18, 2009, entitled “Apparatus for Filling and/or Treatment of Paste-Like Masses, In Particular Sausage Meat,” each of which is hereby incorporated by reference.

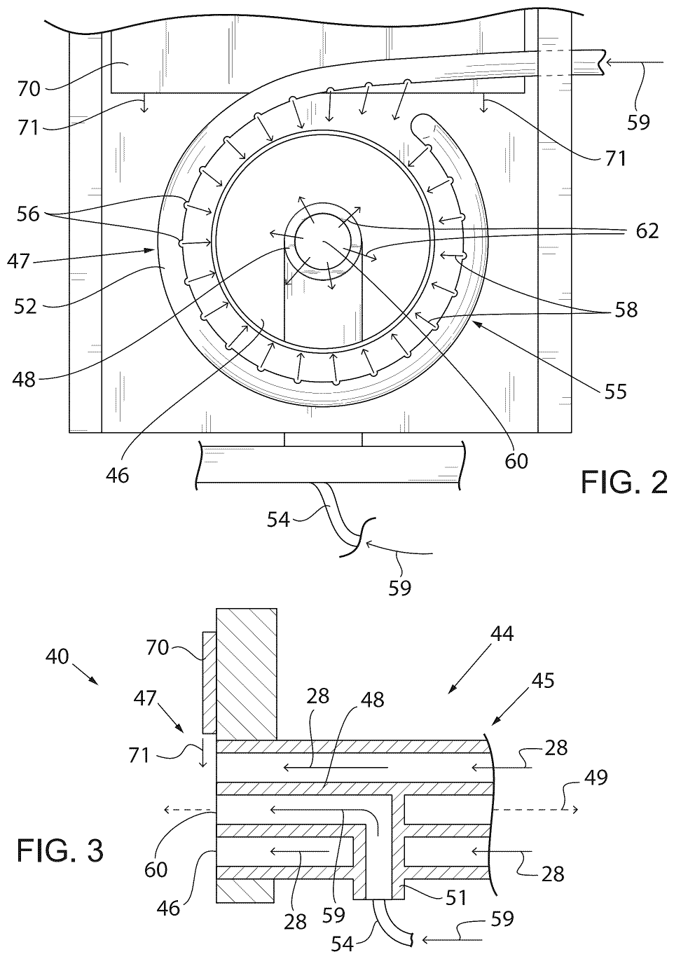

Referring now also to FIGS. 2 and 3, at the extruder head or outlet 26 of the twin-screw system 20 may be a tubular sleeve or connection tube 32 that may be curved or bent to transfer the meat mixture 28 away from the twin-screw system 20 to the portioning assembly 40. The meat mixture 28 may be ejected by the rotational forces of the twin-screw system 20 to travel through the connection tube 32. The meat mixture 28 may be fed from the sleeve or connection tube 32 to a extrusion die 44 to form the meat mixture 28 into a tubular shape. The extrusion die 44 may extend from an inlet side 45 receiving the meat mixture 28 to an outlet side 47 dispensing an extruded tube of meat mixture 37 from the extrusion die 44.

The extrusion die 44 may include a circular orifice 46 with an outer diameter between 0.47-1.02 inches (12-26 mm) and between 0.51-0.63 inches (13-16 mm) and approximately 0.63 inches (16 mm) and approximately 0.63 inches (15.9 mm). The outer diameter of the circular orifice 46 defines the outer diameter of the extruded tube of meat mixture 37. The center of the extrusion die 44 includes a hollow mandrel 48 whose outer diameter creates the inner lumen 120 of the tube, as seen in FIG. 8, and has an outer diameter between 0.16-0.39 inches (4-10 mm) and between 0.20-0.39 inches (5-10 mm) and between 0.28-0.35 inches (7-9 mm) and approximately 0.31 inches (8 mm), or between 0.20-0.28 inches (5-7 mm) and approximately 0.24 inches (6 mm), and an inner diameter between 0.12-0.35 inches (3-9 mm) and between 0.16-0.31 inches (4-8 mm) and approximately 0.20 inches (5 mm). Thus, the outer diameter of the hollow mandrel 48 defines the inner diameter of the extruded tube of meat mixture 37 and provides a small diameter tube.

The hollow mandrel 48 may extend along a central axis 49 of the circular orifice 46 of the extrusion die 44 and may be supported at the center of the circular orifice 46 by a tube portion 51 extending from the hollow mandrel 48 along an axis perpendicular to the central axis 49. The meat mixture 28 is pushed through the circular orifice 46 and surrounds the outside of the hollow mandrel 48, filling the space between the hollow mandrel 48 and the circular orifice 46, in order to extrude the extruded tube of meat mixture 37 having a wall thickness between 0.12-0.31 inches (3-8 mm) and between 0.12-0.2 inches (3-5 mm) and approximately 0.15 inches (4 mm) or between 0.2-0.31 inches (5-8 mm) and approximately 0.20 inches (5 mm). Thus, the extruded tube of meat mixture 37 is “thin walled.”

It is understood that structural (porthole) methods, as described above, and seamless die extrusion methods, as known in the art, may be used to similarly extrude the tubular structure of meat mixture 28.

As best seen in FIG. 3, the extrusion die 44 may be fitted with a spray apparatus 50 proximate the outlet side 47 of the extrusion die 44 that sprays an inner and/or outer surface of the extruded tube of meat mixture 37 with a meat firming solution. The spray apparatus 50 may include an outer tubing 52 that is suspended in a loop 55 around the outer diameter of the circular orifice 46. The diameter of the loop 55 formed by the outer tubing 52 may have a diameter that is greater than the outer diameter of the circular orifice 46 and may be between 0.71-0.98 inches (18-25 mm) in diameter extending around the circular orifice 46. An inner tubing 54 is directed into the tube portion 51 to emit fluid into a hollow interior of tube portion 51 and the hollow mandrel 48. The outer tubing 52 and/or inner tubing 54 may receive a pressurized meat firming solution, for example, calcium chloride solution 59 from a solution source 53 to spray the calcium chloride solution 59, for example, a solution of calcium chloride dissolved in water as further described below.

The outer tubing 52 may include a plurality of small outlet holes 56 spaced apart along a length of the outer tubing 52 and extending along a length defining an inner circumference of the loop 55 formed by the outer tubing 52 such that the spray of pressurized calcium chloride solution 59 is directed inwardly in radial directions 58 onto an outer surface of the extruded tube of meat mixture 37 before or simultaneous with slicing. The plurality of small outlet holes 56 may have a diameter of approximately 0.5-1 mm.

The inner tubing 54 may emit a spray of water through the tube portion 51 and hollow mandrel 48 to an open end 60 of the hollow mandrel 48 such that the spray of pressurized calcium chloride solution 59 is directed outwardly in radial directions 62 and/or in a forward direction along axis 49 onto an inner surface of the extruded tube of meat mixture 37 before it is cut as further described below. The open end 60 of the inner tubing 54 may include a nozzle permitting a shower or mist spray pattern which allows for greater distribution of calcium chloride solution 59 with less pressure on the inner surface of the extruded tube 37. The nozzle may alternatively provide a pinhole providing a single spray stream.

Therefore, the spray apparatus 50 can emit a spray of calcium chloride solution 59 onto the inner surface and/or outer surface of the extruded tube of meat mixture 37. The pressure of the pressurized calcium chloride solution 59 as it exits the small outlet holes 56 of the outer tubing 52 may be between 5-35 psi and between 15-20 psi and approximately 18 psi. The pressure of the pressurized calcium chloride solution 59 as it exits the open end 60 of the hollow mandrel 48 may be between 20-40 psi and approximately 40 psi or approximately 20 psi. The outer tubing 52 and inner tubing 54 may be made from vinyl, rubber, polyurethane, and the like, to withstand the pressure forces of the spray.

In certain embodiments, the inner tubing 54 sprays pressurized meat firming solution into the inner surface of the extruded tube of meat mixture 37 only and use of the outer tubing 52 may be omitted. In these embodiments, the system may use a tank or bath of calcium chloride solution 59 to submerge the extruded tube of meat mixture 37 into calcium chloride solution 59, as further described below.

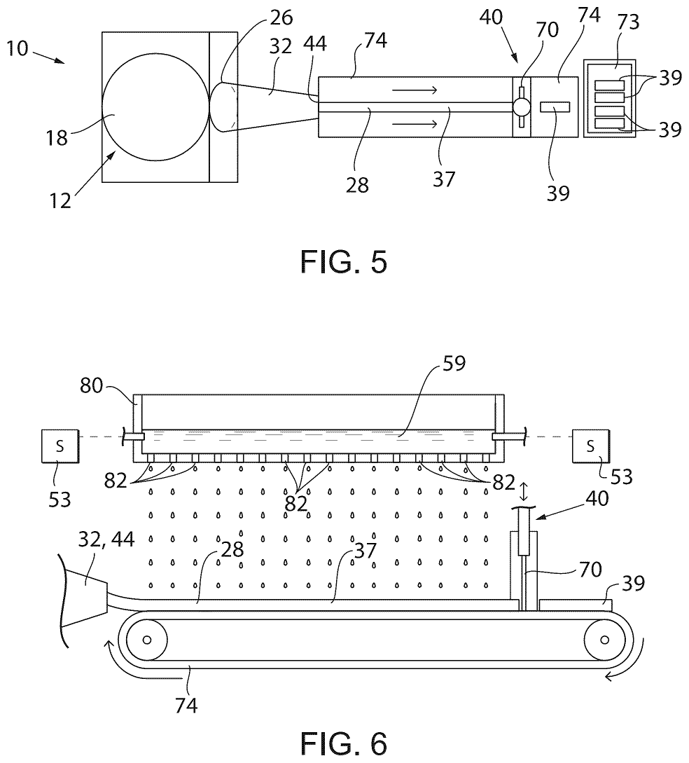

As shown in FIG. 3, the portioning assembly 40 may be positioned close to the outlet side 47 of the extrusion die 44 to be sliced immediately following extrusion or alternatively, may be positioned further downstream to be sliced after firming, as shown in FIG. 5.

In one embodiment, the portioning assembly 40 may include a cutting instrument such as a knife or blade 70 that is programmed to cut the continuously extruded tube of meat mixture 37 at predetermined time intervals to produce desired predetermined lengths of sliced tubes of meat mixture 39. For example, the knife or blade 70 may be a shutter-type or a guillotine-type cutting instrument that is able to cut 30-50 cuts per minute or approximately 40 cuts per minute. In some embodiments, the portioning assembly 40 may include multiple knives or blades 70. The knife or blade 70 may be translated in a downward direction 71 at the outlet side 47 of the extrusion die 44 to cut the extruded tube of meat mixture 37 into the desired predetermined lengths. In one embodiment, the knife or blade 70 may be positioned between the extrusion die 44 and the outer tubing 52. The outer tubing 52 may direct calcium chloride solution 59 onto the extruded tubular meat mixture before and/or simultaneous with the extruded tube of meat mixture 37 being cut by the knife or blade 70. The inner tubing 54 may also direct calcium chloride solution 59 onto the extruded tubular meat mixture before and/or simultaneous with the extruded tube of meat mixture 37 being cut by the knife or blade 70.

In an alternative embodiment the portioning assembly 40 may include a cutting wire 70, similar to a cheese slicer wire, instead of a knife or blade. The cutting wire 70 provides a clean cut as the extruded tube 37 is extruded from the extrusion die 44 without crushing or spreading the extruded tube of meat mixture 37. The cutting wire 70 moves along the front wall of the extrusion die 44 in the downward direction 71 or in an opposite direction to provide an even and consistent cut along the front wall against the forward pressure of the extruded tube of meat mixture 37. The cutting wire 70 can flex slightly to withstand the forward pressure of the extruded tube of meat mixture 37 as the extruded tube 37 is being extruded through the extrusion die 44.

Referring to FIG. 5, in an alternative embodiment, the portioning assembly 40 may be located downstream of the extrusion die 44 and separated from the extrusion die 44 by a conveyor belt 74, as shown. The moving conveyor belt 74 may be approximately 6-12 inches wide and 6-10 feet long with an AC inverter speed controller controlling the speed of the moving conveyor belt 74. Thus, the extruded tubes of meat mixture 37 may be sliced by the portioning assembly 40, i.e., knife or blade or wire 70, after being translated along the conveyor belt 74. In this respect, the portioning assembly 40 may be positioned downstream to allow the extruded tube of meat mixture 37 more time to harden prior to slicing.

Thus, following slicing, the sliced tube of meat mixture 39 may drop onto the conveyor belt 74 generally moving at a speed consistent with the speed of extrusion to transport the sliced tube of meat mixture 39 to additional collection tanks or baths. The extruded tube of meat mixture 37 may travel for 10 to 20 seconds and at least 10 seconds and at least 15 second along the moving conveyor belt 74 prior to slicing.

Referring briefly now to FIG. 6, in an alternative embodiment, in addition to or replacing the spray apparatus 50, a trough 80 being substantially the same width and length of the moving conveyor belt 74 may provide a container holding additional calcium chloride solution 59 held above the moving conveyor belt 74. The trough 80 may receive calcium chloride solution 59 which is pumped from the solution source 53 and re-circulated back to the solution source 53. Small holes 82 in the floor of the trough 80 may allow calcium chloride solution 59 to drip or “shower” down onto the extruded tube of meat mixture 37 as it travels along the moving conveyor belt 74 in order to gently coat the outside of the extruded tube of meat mixture 37 with the calcium chloride solution 59. The small holes 82 may extend along the length of the trough 80 and toward the center of the width of the trough 80 to fall onto the extruded tube of meat mixture 37 which is generally centered along the width of the conveyor belt 74. The moving conveyor belt 74 may include openings allowing the calcium chloride solution 59 to drain from the conveyor belt 74 and into a collection container or drain (not shown).

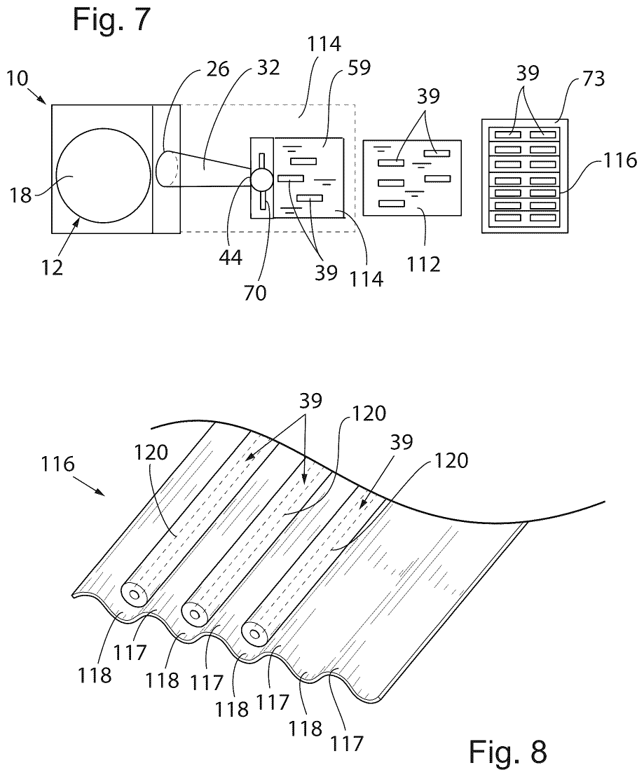

In certain embodiments, following slicing as shown in FIGS. 1-2 and FIGS. 5-6, the sliced tubes of meat mixture 39 may drop down into and be held within a high concentration calcium chloride solution 59 for firming (as seen in FIG. 7), followed by being held in a tank or bath of rinsing water 112 for rinsing (as seen in FIG. 7), followed by being held in a collection bin 72 (as seen in FIG. 1) or on a collection tray 73 (as seen in FIGS. 5 and 7) prior to the dehydrating steps described below.

Referring now to FIG. 7, the extruded tube of meat mixture 37 may be dropped down into a tank or bath 114 of calcium chloride solution 59 and immersed within the calcium chloride solution 59 after the extruded tube of meat mixture 37 is cut by the knife or blade 70. In this embodiment, the outer tubing 52 spraying calcium chloride solution 59 on the outer surfaces of the extruded tube of meat mixture 37 may be omitted and the outer surfaces of the sliced tubes of meat mixture 39 may be coated with calcium chloride solution 59 by immersing or soaking the sliced tubes of meat mixture 39 within the tank or bath 114 instead.

In yet another alternative embodiment, the portioning assembly 40 itself may be held within a large vat 114 of calcium chloride solution 59. In this respect, the extruded tube of meat mixture 37 is extruded and cut into and within the calcium chloride solution 59. In this embodiment, the outer tubing 52 may be omitted, and optionally, the inner tubing 54 may be omitted, and the outer surfaces (and inner surfaces) of the sliced tubes of meat mixture 39 may be coated by immersing or soaking the sliced tubes of meat mixture 39 within the tank or bath 114.

By immersing or soaking the sliced tubes of meat mixture 39 within the calcium chloride solution 59, the calcium chloride solution 59 exerts outer pressure on the sliced tubes of meat mixture 39 against the inner pressure caused by the pressurized calcium chloride solution 59 on the inside of the extruded tube of meat mixture 37 provided by the inner tubing 54. This pressure balance prevents holes from forming within the sliced tubes of meat mixture 39 caused by the inner pressure of the inner spray. Further, by soaking the sliced tubes of meat mixture 39 within high concentration calcium chloride solution 59, full activation of the sodium alginate is permitted within the walls of the sliced tubes of meat mixture 39 to harden the tubes.

The sliced tubes of meat mixture 39 may be soaked within the tank or bath 114 of calcium chloride solution 59 for at least one minute and for approximately three to four minutes. In one embodiment, the tank or bath 114 of calcium chloride solution 59 is a long tank or “lazy river” permitting the sliced tubes of meat mixture 39 to float downstream for at least one minute and for approximately three to four minutes. In this respect, the length of the tank of solution may allow for at least one minute and approximately three to four minutes of soaking.

The high length-to-diameter ratio of the extruded tube of meat mixture 37 makes the tubes more prone to collapse than short tubes. For example, the length-to-diameter ratio of the extruded tube of meat mixture 37 may be as high as 10:1 to 20:1 where the length is significantly greater than its diameter. It is understood that the interaction between the sodium alginate of the meat mixture 28 and high concentration calcium chloride of the calcium chloride solution 59, by coating the inside and/or outside of the extruded tube of meat mixture 37 and then submerging the extruded tube 37 within a bath of high concentration calcium chloride solution 59, causes the sodium alginate to crosslink and a setting action to take place quickly within the walls and within the meat mixture 28 to prevent the extruded tube of meat mixture 37 from collapsing. Additionally, the thin walls of the extruded tube of meat mixture 37 assist with allowing calcium chloride to seep more easily into the meat mixture 28 to activate the sodium alginate.

Following immersion or soaking within the tank or bath 114, the sliced tubes of meat mixture 39 may be received by an additional tank or bath of rinsing water 112 to rinse off the high concentration calcium chloride solution 59 from the outer surfaces of the sliced tubes of meat mixture 39. This rinsing process eliminates the salty taste of the high concentration calcium chloride solution 59 prior to drying. The sliced tubes of meat mixture 39 may be rinsed for at least one minute and for approximately one to two minutes.

It is understood that the conveyor belt 74 of FIGS. 5-6 may be used to move the sliced tubes of meat mixture 39 to a tank or bath 114 of calcium chloride solution 59, a trough of rinsing water 112, and/or collection bins 72 or collection trays 73.

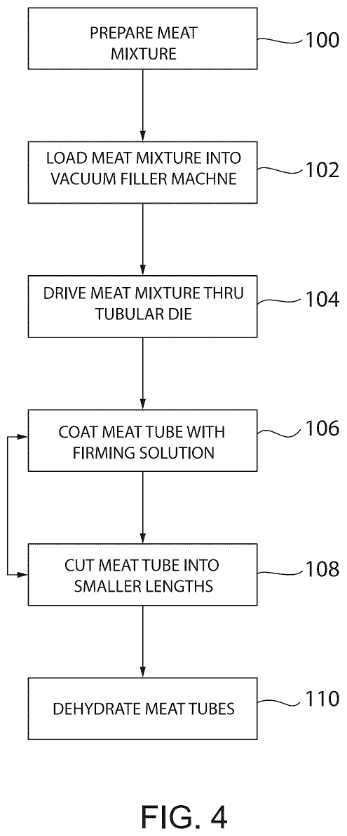

Referring now to FIG. 4, describing the method of making the meat tubes, as illustrated by step 100, the meat mixture 28 may be prepared using a combination of lean ground beef, seasoning mixture/spices, sodium nitrite, sodium alginate, curing salt (optional), and water (optional). The sodium nitrite is a salt additive and anti-oxidant that is used to add the color and flavor of dehydrated meats. The sodium alginate is a salt additive that is used to preserve foods and inhibit the growth of bacterial spores. The optional curing salt or “pink curing salt” is a high sodium product used to add flavor.

The meat mixture 28 may contain between 85-95 wt % ground beef or lean ground beef and 90-95 wt % ground beef or lean ground beef and at least 85 wt % and at least 90 wt % and approximately 87 wt % ground beef or lean ground beef and approximately 93 wt %; between 1-5 wt % seasoning and sodium nitrite mixture and at least 3 wt % and at least 3.5 wt % and approximately 3 wt % seasoning and sodium nitrite mixture; between 0-10 wt % water and at least 3 wt % and at least 5 wt % and approximately 3 wt % and approximately 5 wt % water; between 0.5-1.5 wt % sodium alginate and at least 0.5 wt % and less than 1% sodium alginate and approximately 1 wt % sodium alginate; between 0-3 wt % curing salt and at least 2 wt % and approximately 2 wt % curing salt.

The meat mixture 28 is generally not uniform after grinding and mixing, rather, containing larger fibrous chunks and smaller mushy bits. Therefore, to improve the uniformity of the meat mixture 28, the process includes taking 10% of the meat mixture and regrinding, beating, and whipping it into a “slimy” meat consistency. The 10% slimy meat mixture is then blended back into the 90% meat mixture. This allows the 10% slimy meat mixture to fill the voids within the non-uniform 90% meat mixture for greater uniformity.

As illustrated by step 102, the meat mixture 28 may be loaded into the hopper 12 of the vacuum filler machine 10 as shown in FIG. 1. The vacuum system 21 may pull the meat mixture 28 into the twin-screw system 20. The twin-screw system 20 may drive the meat mixture 28 through the connection tube 32 and through the extrusion die 44 to the portioning assembly 40. In one embodiment, the settings of the vacuum filler machine 10 may be as follows: Weight=0200 (i.e., how long the twin-screws should turn to pump out the entire quantity of mean mixture), HT-N/A (i.e., adjustment for links), Pause=220 (i.e., milliseconds of stop time on screws while blade cuts tube), Twist=100 (i.e., firing time of blade to cut tube in milliseconds), Speed=35 (i.e., percent of maximum screw speed).

As illustrated by step 104, at the portioning assembly 40, the meat mixture 28 is extruded through the extrusion die 44 to produce the extruded tube of meat mixture 37. The extruded tube of meat mixture 37 may have an outer diameter that is at least 0.47 inches (12 mm) and less than 1.02 inches (26 mm) and between 0.47-1.02 inches (12-26 mm) and between 0.51-0.63 inches (13-16 mm) and approximately 0.63 inches (16 mm) and approximately 0.59 inches (15 mm), and an inner diameter that is at least 0.16 inches (4 mm) and less than 0.39 inches (10 mm) and between 0.16-0.39 inches (4-10 mm) and between 0.20-0.39 inches (5-10 mm) and between 0.28-0.35 inches (7-9 mm) and approximately 0.31 inches (8 mm), or between 0.20-0.28 inches (5-7 mm) and approximately 0.24 inches (6 mm).

As illustrated by step 106, during or after the meat mixture 28 is extruded, the spray apparatus 50 may wet the inside and/or outside (inner surface and/or outer surface) of the extruded tube of meat mixture 37 with the calcium chloride solution 59 which may be held within a solution source 53, e.g., a container or basin holding the solution.

The calcium chloride solution 59 loaded into the solution source 53 may be between 0.5-1.5 wt % calcium chloride and approximately 1 wt % calcium chloride and between 98-99 wt % water and approximately 99 wt % water. In an alternative embodiment, a higher concentration calcium chloride solution 59 may be used and may be 5-15 wt % calcium chloride and at least 5 wt % and approximately 10 wt % calcium chloride and between 85-95 wt % water and at least 90 wt % water and approximately 90 wt % water.

In an alternative embodiment of the invention described above with respect to FIGS. 5-6, the spraying process of step 106 completed by the spray apparatus 50 may be at least partially substituted by a showering process in which the trough 80 of calcium chloride solution 59 may shower calcium chloride solution 59 onto the extruded tube of meat mixture 37 as it passes on the moving conveyor belt 74.

In an alternative embodiment of the invention described above with respect to FIG. 7, the spraying process of step 106 completed by the spray apparatus 50 may be at least partially substituted by a submersion process in which the extruded tube of meat mixture 37 is submerged in the calcium chloride solution 59 after the extruded tube of meat mixture 37 is cut. For example, the sliced tubes of meat mixture 39 may be dropped into the tank or bath 114 holding calcium chloride solution 59 and immersed in calcium chloride solution 59 within the tank or bath 114 following slicing.

In this respect, it is understood that alternative methods of coating the inside and/or outside of the extruded tube of meat mixture 37 with the calcium chloride solution 59 during or after slicing the extruded tube of meat mixture 37 are contemplated by the present invention.

As illustrated by step 108, the extruded tube of meat mixture 37 is cut or sliced by the knife or blade 70 or cutting wire 70 into desired predetermined lengths and, optionally, further dropped into the tank or bath of rinsing water 112 to rinse off the high concentration calcium chloride solution 59, and then collected by the collection bin 72 or dropped directly onto a collection tray 73 to be further loaded into the dryer or dehydrator.

In one embodiment of the present invention, the desired predetermined length of the sliced tubes of meat mixture 39 may be between 6-10 inches and between 7-9 inches and approximately 8 inches and approximately 8 and ⅜ inches and approximately 8.5 inches. The sliced tubes of meat mixture 39 may include between 1-2 oz. and approximately 1.2 oz. (34 g) of meat mixture 28. These length measurements are taken before drying or dehydrating.

As illustrated in step 110, the sliced tubes of meat mixture 39 are recovered from the collection bin 72 and then placed on a collection tray 73 for transfer to a dryer or dehydrator for baking. The collection tray 73 may hold support racks 116 to assist with forming straight sliced tubes of meat mixture 39.

Referring briefly to FIG. 8, the support racks 116 may be used to maintain the straightness of the sliced tubes of meat mixture 39 during dehydration by providing U-shaped hills 117 and valleys 118 that hold and cradle each sliced tube of meat mixture 39. The support rack 116 may be dimensioned similarly to the collection tray 73 and manufactured of wire mesh sheets or stainless-steel sheets bent to provide U-shaped hills 117 and valleys 118 when viewed in cross section across the width or length of the collection tray 73. The U-shaped valleys 118 provide lateral or longitudinal channels for receiving the sliced tubes of meat mixture 39 in straight lines.

The dryer, dehydrator, or smoker may be a heated cabinet operating at a temperature of at least 150 degrees Fahrenheit and approximately 160 degrees Fahrenheit, and the sliced tubes of meat mixture 39 are heated for approximately 2-8 hours while heat is circulated therein the dryer or dehydrator. For example, the sliced tubes of meat mixture 39 may be cooled at 140 F for 1 hour, 150 F for 1 hour, 160 F for 1 hour, 170 F for 1 hour, and 155 F for 15 minutes. If a smoker is used, wood chip smoke may be integrated into the drying process, e.g., during the first hour of cooking.

As the sliced tubes of meat mixture 39 are dried, the meat shrinks, opening the cut ends of the sliced tubes of meat mixture 39. Approximately 0.6 oz. (17 g) water is removed from the sliced tubes meat mixture 39 during the dehydration or drying process to leave approximately 0.6 oz. (17 g) of dried meat. The moisture to protein ratio of the dried meat is 0.75:1 or lower. The water activity (aw) may be 0.71-0.79 and about 0.79 indicating that the food is stable with respect to bacterial growth. Following the drying process, the sliced tubes of meat mixture 39 may be placed within a freezer for cooling and storage.

The final product is a firm and edible tube of meat jerky. The meat jerky provides meat and smoky flavoring to the liquid that is being transported through the tube.

The meat jerky may be packaged in plastic bags that are nitrogen gas flushed, or vacuum packed for future consumption. The meat jerky may also be sealed with oxygen absorber to prevent the oxidation of fat.

The following examples are offered for illustrative purposes only and are not intended to limit the scope of the present invention in any way. Various modifications of the invention in addition to those shown and described herein will become apparent to those skilled in the art from the foregoing description and the following examples and fall within the scope of the appended claims.

### Example 1—Preparation of Meat Mixture

In one embodiment of the present invention, the meat mixture 28 includes the following ingredients and approximate amounts of those ingredients.
9000 g—80 wt % lean/20 wt % fat ground beef
320 g—seasoning and sodium nitrite mixture
50 g—sodium alginate
300 g—water (optional)

The meat mixture may be prepared by adding the seasoning mixture and sodium alginate to water to form a paste. The ground beef may be placed into an 80-quart mixer and the paste may be added to the ground beef.

The resulting meat mixture may be allowed to rest for 30 minutes at approximately 38 degrees Fahrenheit.

### Example 2—Preparation of Meat Mixture

In one embodiment of the present invention, the meat mixture 28 includes the following ingredients and approximate amounts of those ingredients.
13800 g—80 wt % lean/20 wt % fat ground beef
600 g—seasoning mixture
350 g—curing salt
150 g—sodium alginate
900 g—water

The meat mixture may be prepared by mixing the dry ingredients (seasoning mixture, curing salt, sodium alginate) in a bowl. The water is placed into a medium mixer bowl (20 quart) and the dry ingredients slowly added to make a paste by whisking the mixture at medium speed. The ground beef and paste are placed in a large mixer bowl (60 quart). The mixture is mixed for 30 seconds on low speed then mixed for two minutes on medium speed.

The mixture is spread out on a pan and placed in the refrigerator for 60 minutes, cooling the mixture to 45 degrees Fahrenheit.

### Example 3—Preparation of Meat Mixture

In one embodiment of the present invention, the meat mixture 28 includes the following ingredients and approximate amounts of those ingredients.
93.75% ground beef
5% spices
1% sodium alginate
0.25% curing salt

Approximately 24 hours before production, fresh beef whole muscle may be ground fine at an approximately 93/7 fat ratio. For example, a 40 lb. batch may be made. The ingredients above are mixed, 1 hour after the beef was ground. The beef mixture is rested overnight for approximately 20 hours in a 37-degree refrigerator. The beef mixture is moved into the freezer 1 hour before production, bringing the temperature to 34 degrees when extrusion began.

### Example 4—Preparation of Firming Solution

In one embodiment of the present invention, the calcium chloride solution 59 includes the following ingredients and approximate amounts of those ingredients:
17,000 g of water
200 g calcium chloride

### Example 5—Preparation of Firming Solution

In one embodiment of the present invention, the calcium chloride solution 59 includes the following ingredients and approximate amounts of those ingredients:
20,000 g of water
200 g calcium chloride

### Example 6—Preparation of Firming Solution

In one embodiment of the present invention, the higher concentration calcium chloride solution 59 includes the following ingredients and approximate amounts of those ingredients:
20,000 g of water
2000 g calcium chloride

Certain terminology is used herein for purposes of reference only, and thus is not intended to be limiting. For example, terms such as “upper,” “lower,” “above,” and “below,” refer to directions in the drawings to which reference is made. Terms such as “front,” “back,” “rear,” “bottom,” and “side,” describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first,” “second,” and other such numerical terms referring to structures do not imply a sequence or order unless clearly indicated by the context. Although the stator and rotors are shown as disks in the disclosed embodiments, there is no requirement that the stator or rotor be in a disk form.

When introducing elements or features of the present disclosure and the exemplary embodiments, the articles “a,” “an,” “the,” and “said,” are intended to mean that there are one or more of such elements or features. The terms “comprising”, “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What I claim is:

1. A method of making a drinking straw of dried meat comprising:
forming a meat composition comprising ground meat and sodium alginate;
passing the meat composition along an axis through a die having a ring-shaped opening with an outer diameter and inner diameter concentric about the axis with the meat composition configured to be extruded between the inner diameter and outer diameter of the ring-shaped opening to form a narrow tube of extruded meat;
spraying an inner surface of the tube of extruded meat with a solution of calcium chloride;
cutting the tube of extruded meat into predetermined length tubes;
submerging the predetermined length tubes within a bath of the solution of calcium chloride; and
drying the predetermined length tubes to remove moisture from the extruded meat.

2. The method of claim 1 wherein the solution of calcium chloride is at least 5 wt % calcium chloride in water.

3. The method of claim 2 wherein the solution of calcium chloride is 5-15 wt % calcium chloride in water.

4. The method of claim 1 further comprising:
rinsing the smaller length tubes within a bath of water before drying the predetermined length tubes.

5. The method of claim 1 further comprising:
extending a spray tubing through a center of the die; and
emitting the solution of calcium chloride through an open end of the spray tubing.

6. The method of claim 5 wherein the solution of calcium chloride is emitted at 20-40 psi.

7. The method of claim 6 wherein the solution of calcium chloride is emitted at approximately 20 psi.

8. The method of claim 1 wherein submerging the smaller length tubes within the bath of the solution of calcium chloride is for at least one minute.

9. The method of claim 8 wherein submerging the smaller length tubes within the bath of the solution of calcium chloride is for three to four minutes.

10. The method of claim 1 wherein the predetermined length tubes have a water activity of 0.71-0.79 after drying.

11. The method of claim 1 wherein the predetermined length tubes have a length-to diameter ratio of at least 10:1.

12. An assembly for making a drinking straw of dried meat comprising:
a hopper receiving a meat mixture;
an extruder passing the meat mixture from the hopper through a barrel translating the meat mixture along the barrel;
a die having a ring shaped opening and permitting the meat mixture to be fed through the die to produce a tube of extruded meat having an inner lumen and an outer surface;
a cutting instrument slicing the tube of extruded meat into predetermined length tubes;
a tube extending through the die configured to spray the inner lumen of the tube of extruded meat with a solution of calcium chloride; and
a bath of the solution of calcium chloride to coat the outer surface of the tube of extruded meat with a solution of calcium chloride.

13. The assembly of claim 12 further comprising a tank of water to rinse the solution of calcium chloride from the tube of extruded meat.

14. The assembly of claim 13 wherein the bath of the solution of calcium chloride is 5-15 wt % calcium chloride in water.

15. The assembly of claim 12 further comprising
a support rack having at least one valley extending along an axis wherein a cross section taken perpendicular to the axis is U-shaped configured to receive the tube of extruded meat along the axis within the at least one valley.

16. The assembly of claim 12 wherein the cutting instrument is a blade configured to slide across the opening of the die.

17. The assembly of claim 12 wherein the cutting instrument is a wire configured to slide across the opening of the die.

18. The assembly of claim 12 wherein the meat mixture is 90 to 95 wt % ground beef and 0.5 to 1.5 wt % sodium alginate.

19. The assembly of claim 18 wherein the meat mixture further comprises spices and curing salt.

20. The assembly of claim 12 wherein the predetermined length tubes have a length-to diameter ratio of at least 10:1.
